(19) United States
(12) Patent Application Publication
(10) Pub. No.: US 2011/0045269 A1
(43) Pub. Date: Feb. 24, 2011

(54) COMPONENT WITH TOP LAYER OF A PA613 MOULDING COMPOUND

(75) Inventors: Roland Wursche, Duelmen (DE); Sonja Bollmann, Haltern am See (DE); Franz-Erich Baumann, Duelmen (DE); Beatrice Kueting, Marl (DE); Kirsten Luetzeler, Muenster (DE); Andreas Pawlik, Recklinghausen (DE); Martin Wielpuetz, Senden (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/989,899

(22) PCT Filed: Jun. 23, 2009
(86) PCT No.: PCT/EP09/57750

§ 371 Date: Oct. 27, 2010

(30) Foreign Application Priority Data
Jun. 24, 2008 (DE) 10 2008 002 599.2

(51) Int. Cl. B32B 27/34; B32B 27/08; C08G 63/685

(52) U.S. Cl. 428/220; 428/474.4; 428/476.3; 428/475.2; 428/412; 428/413; 428/423.5; 428/473.5; 428/419; 428/474.7; 528/288

(57) ABSTRACT

A component which comprises the following components: I. a top layer of a moulding compound which contains at least 50% by weight of PA613 and II. a substrate of a thermoplastic moulding compound has a surface with high scratch resistance and high chemical resistance.

The present invention relates to a component which comprises an external layer or, respectively, outer layer made of a PA613 molding composition. The invention further relates to a decorative film which can be used for producing a component of this type, and which comprises a layer based on PA613.

The use of thermoplastic components with an outer layer made of another material is standard when the intention is that the surface of the component be protected from exterior effects and, if appropriate, decorated.

The current standard process for decorating external areas on automobiles is painting. However, this procedure firstly generates high manufacturing costs, resulting from provision of specific plant and the operating cost associated therewith for the automobile producer, and secondly causes pollution of the environment. Pollution of the environment derives by way of example from solvent constituents released from the paints used, and also from accumulation of paint residues, which have to follow correct disposal routes.

Another factor is that painting has only limited suitability for decorating the surfaces of plastics components, which in recent years have become more popular in automobile construction, because of the saving in weight and cost.

The process of painting plastics components which are components of bodywork can, for example, be carried out on-line, the plastics part being subjected to a paint treatment identical with that for the metallic components. This leads to uniform color, but is attended by high temperatures resulting from the cathodic electrodeposition method conventional here, and this makes the selection of material more difficult. In addition, identical adhesion of the paint formulation has to be ensured on very different substrates. If the process of painting the plastics parts is carried out in a separate step (known as off-line painting), comprising process conditions more advantageous for plastics, the problem of colormatching arises, meaning that the shade achieved on the metal has to be matched precisely. However, the differences in substrate and in the underlying paint formulation that can be used, and process conditions, make this very difficult to achieve. If there is a color difference prescribed by the design, a serious disadvantage that remains is provision of a second set of painting equipment for the plastics parts and the cost associated therewith, and the additional time required for manufacture of the automobile also has to be considered. Direct use of the untreated, generally injection-molded plastics parts is esthetically disadvantageous, because surface defects resulting from the process are clearly discernible here, examples being weld lines, air inclusions, and also any necessary reinforcing fillers, such as glass fibers. This is unacceptable in visible regions. Consequently, improvement of surface quality has to be undertaken, for example in the context of a painting process, frequently requiring much work for pretreatment by polishing and application of relatively thick layers of a primer.

One proposed solution consists in the use of multilayered plastics films, used to cover the components and then requiring no painting. The bond between the substrate and decorative film can be achieved here via a number of manufacturing processes. By way of example, the film can be laminated to the substrate, or it is possible to select a process of reverse coating by an injection-molding process, in which the film is placed in the injection mold during component production. The concept of a film as carrier of decoration is also in line with a trend toward individualization of design elements on automobiles. Specifically, this trend leads to a wider range of models in the manufacturing process, but with a reduction in the number of respective components manufactured per series. The use of films permits rapid, problem-free design change, and can therefore meet this challenge. An important factor here is that the film complies with the standards demanded in the automobile industry with respect to surface properties (class A surface), solvent resistance, and appearance. Films having properties of this type are likewise very useful in the design of surfaces in the interior of automobiles.

Decorative films of this type are in principle known. EP 0 949 120 A1 describes by way of example decorative films with polyalkyl methacrylate as base layer, and these can also comprise a polyamide supportive layer on the substrate side, while WO 94/03337 discloses decorative films in which the base layer can be composed of a wide variety of polymer alternatives, among which is polyamide. EP 0 285 071 A2 is another example of a multilayer system. The advantage of a multilayer structure is that the various individual layers act together to provide an ideal system solution. Each layer here within the multilayer film is responsible for one or more specific functions within the context of the entire system.

Annual Technical Conference—Society of Plastics Engineers 2001, 59, 2471-2475 describes decoratable, transparent films made of polyamide in sports applications.

In very general terms, the property profile of polyamides, in particular polyamides based on PA12 or PA11, makes them very suitable for producing decorative films of this type, examples of these properties being impact resistance and chemicals resistance. Accordingly, the patent literature contains descriptions of decorative films or else protective films which comprise an outer layer made of a polyamide. Examples that may be mentioned here are the following specifications: JP60155239A, JP2003118055A, EP 1 302 309 A, EP 0 522 240 A, EP 0 694 377 A, EP 0 734 833 A, WO 9212008 A, WO 2006008357 A, WO 2006008358 A, and EP 0 568 988 A.

While outer layers made of polyamides having high carbonamide-group density have inadequate chemicals resistance and excessive water absorption, due to high polarity, it is found in practice that when polyamides having low carbonamide-group density are used, produced from lactams or from the corresponding aminocarboxylic acids (AB polyamides), deposits are formed on the surface of the films over the course of time under ambient conditions, and these considerably reduce gloss and are unacceptable for said application. Transparency and scratch resistance are also unsatisfactory. In contrast, if polyamides made of diamine and dicarboxylic acid (AABB polyamides) having low density of carbonamide groups are used, no deposits form, but here again transparency is unsatisfactory.

In many instances, the components requiring decoration or protection are transparent. Transparent components such as lenses, displays, paneling, viewing windows, etc. are frequently produced from amorphous materials, such as polycarbonate, PMMA, or transparent polyamides. Although these have good transparency, they exhibit poor chemicals resistance and low scratch resistance. The low chemicals resistance is disadvantageous for applications where contact of these materials with chemicals or solvents can arise, since phenomena such as haze or cracking can occur. Poor scratch resistance shortens the lifetime of the transparent objects, since scratching likewise causes undesired haze.

In principle, it is possible to use an outer layer made of a semicrystalline polyamide in order to improve resistance of transparent objects to chemicals. By way of example, EP 0 696 501 A2 says that said defect can be eliminated by using a polyamide coating which has good adhesion on polyalkyl (meth)acrylate moldings, but an adhesion promoter has to be used here. DE 197 02 088 A1 describes the application of said concept to polyarylate moldings. Further prior art is found in WO 2005/123384, WO 2006/072496, WO 2006/087250, WO 2006/008357, and WO 2006/008358; here, a film which comprises a layer made of a polyamide molding composition is bonded to a substrate, e.g. by reverse coating by an injection-molding method. Other specifications that may be mentioned by way of example are JP60155239A, JP2003118055A, EP 1 302 309 A, EP 0 522 240 A, EP 0 694 377 A, EP 0 734 833 A, WO 9212008 A and EP 0 568 988 A. However, said prior art does not provide any solution to the problem of combining high chemicals resistance with high scratch resistance.

The films disclosed in WO 2006/087250 and EP 1 731 569 A1 achieve an improvement in relation to formation of deposit and to transparency. However, at relatively high layer thicknesses, the transparency of the compositions proposed for the outer layer in those publications is unsatisfactory.

The object of the invention consists in providing a component with surface that features improved scratch resistance and high chemicals resistance. The material of the outer layer here should be sufficiently transparent to permit production of transparent components even when layer thicknesses are relatively great, if the substrate of the component is transparent. A further aspect of the object consisted in provision of decorative films with an outer layer made of an aliphatic polyamide, where these are suitable for producing components of said type, and where on the one hand the transparency of the outer layer should be improved over the prior art, but on the other hand the molding composition of the outer layer should have sufficient crystallinity to provide adequate stress-cracking resistance and resistance to solvents and to chemicals. Formation of deposit should moreover be suppressed, if possible completely.

Said object has been achieved via a component which comprises the following component parts:
I. an outer layer made of a molding composition which comprises at least 50% by weight, preferably at least 60% by weight, particularly preferably at least 70% by weight, with particular preference at least 80% by weight, and very particularly preferably at least 90% by weight, of PA613, and
II. a substrate made of a thermoplastic molding composition.

PA613 can be produced in a known manner by polycondensation of hexamethylenediamine and 1,13-tridecanoic acid. The PA613 is preferably a homopolymer; however, it can also be a copolymer having at most 30 mol %, preferably at most 20 mol %, and particularly preferably at most 10 mol %, of one or more comonomer units. The comonomer units can derive from any desired monomer that is conventionally used for producing polyamides, examples being caprolactam, laurolactam, sebacic acid, dodecanedioic acid, 1,10-decanediamine, 1,12-dodecanediamine, 4,4′-diaminodicyclohexylmethane, or isophoronediamine.

In one preferred embodiment, at most 45%, at most 40%, at most 35%, at most 30%, or at most 25%, of all of the end groups in the PA613 are amino groups. The result can be avoidance of yellowing of the film due to thermooxidative degradation. The production of this type of end-group-regulated polyamide is prior art, by addition of a dicarboxylic acid or monocarboxylic acid as a regulator.

The molding composition based on PA613 can also by way of example comprise the following further component parts:
a) nucleating agents, selected from nanoscale fillers and basic metal salts, metal oxides, or metal hydroxides; in order to provide the desired transparency, the amount added of the latter is at most the amount that can be dissolved in the melt, with reaction with the carboxy end groups of the polyamide;
b) conventional auxiliaries or additives, the amounts of these being those usual for polyamide molding compositions, examples being stabilizers, UV absorbers, or lubricants,
c) colorants which do not significantly affect transparency,
d) fillers, the refractive index of which differs only slightly from, or is exactly identical with, that of the matrix (isorefractive fillers),
e) further polymer components, the refractive index of which differs only slightly from, or is exactly identical with, that of the matrix, and also nucleating agents based on organic compounds, where these do not substantially affect transparency.

The effective number-average particle diameter d₅₀ of any nanoscale fillers present in the molding composition is less than 150 nm, preferably less than 120 nm, particularly preferably less than 90 nm, with particular preference less than 70 nm, and very particularly preferably less than 50 nm or less than 40 nm.

The effective particle diameter must not be confused with the primary particle diameter. The decisive factor for transparency is not the latter, but instead is the size of the aggregates or agglomerates actually present within the molding composition. However, if dispersion is very good the effective particle diameter can decrease as far as the diameter of the primary particles, in the limiting case.

The effective particle diameters of nanoscale particles or aggregates or agglomerates thereof in molding compositions, and the associated distribution function, are determined by preparing a thin section of the molding composition. In the case of polyamides, it is advantageous to prepare a low-temperature thin section at −100° C. A number of transmission electron micrographs are then prepared in order to permit statistical evaluation using a sufficiently large number of particles. In a particular case, this number of particles is at least two hundred, but preferably a thousand particles. An evaluation program is used to measure the diameter of the particles. The data obtained are converted to a distribution function.

The presence of the particulate additions or the nanoparticles is not permitted to impair transparency of the molding composition by more than 2%, when it is measured to ASTM D1003 on a film of thickness 200 μm, with light of wavelength of 589 nm.

It is preferable that the outer layer, any adhesion-promoter layer present, and any further layers present comprise at most 1% by weight of nanoparticles. This amount is entirely sufficient for the purposes of nucleation or laser inscription.

The polyamide molding composition of I. can comprise at most 20% by weight, at most 16% by weight, at most 12% by weight, at most 8% by weight, or at most 4% by weight, of auxiliaries or additives, where the % by weight data are based on the entire polyamide composition.

The molding composition can moreover also comprise at least one further polyamide, preferably one of which the monomer units contain on average at least 8 carbon atoms, examples being PA610, PA612, PA614, PA88, PA810, PA812, PA1010, PA1012, PA1014, PA1212, PA11 or PA12.

Examples of suitable substrates are molding compositions based on polyolefins, on polyamides, on polyesters, on polyacrylates, on polycarbonates, on ABS, on polystyrene, or on styrene copolymers, or curable systems such as those based on epoxy resin or polyurethane.

In one possible embodiment, the substrate has a maximum of at least 30%, and preferably of at least 35%, 40%, 45%, 50%, 55%, 60%, 65%, 70%, 75%, or 80% in the transmittance curve at from 380 to 800 mm within the visible spectrum, where transparency is determined to ASTM D1003 on injection-molded sheets and the thickness of the layer is 1 mm. Substrates of this type are substantially transparent.

There is no restriction on the nature of the substantially amorphous polymer which forms the basis for the molding composition of the substrate. In principle, any known substantially amorphous polymer can be used. Examples here are polyamides, polyalkyl (meth)acrylates, polycarbonate, polyester carbonate, polyesters, polyimides, polyetherimides, polymethacrylimides, polysulfone, styrene polymers, polyolefins having cyclic units, olefin-maleimide copolymers or polymers based on vinylcyclohexane.

The enthalpy of fusion of the substantially amorphous polymer is preferably less than 12 J/g, with preference less than 8 J/g, particularly preferably less than 6 J/g, with particular preference less than 4 J/g and very particularly preferably less than 3 J/g, measured by the DSC method to ISO 11357 during the 2nd heating procedure, integrating any melting peak present.

Examples of substantially amorphous polyamides that can be used according to the invention are:
the polyamide composed of terephthalic acid and/or isophthalic acid and of the isomer mixture composed of 2,2,4- and 2,4,4-trimethylhexamethylenediamine,
the polyamide composed of isophthalic acid and 1,6-hexamethylenediamine,
the copolyamide composed of a mixture of terephthalic acid/isophthalic acid and 1,6-hexamethylenediamine, if appropriate in a mixture with 4,4′-diaminodicyclohexylmethane,
the copolyamide composed of terephthalic acid and/or isophthalic acid, 3,3′-dimethyl-4,4′-diaminodicyclohexylmethane and laurolactam or caprolactam,
the (co)polyamide composed of 1,12-dodecanedioic acid or sebacic acid, 3,3′-dimethyl-4,4′-diaminodicyclohexylmethane and, if appropriate, laurolactam or caprolactam,
the copolyamide composed of isophthalic acid, 4,4′-diaminodicyclohexylmethane and laurolactam or caprolactam,
the polyamide composed of 1,12-dodecanedioic acid and 4,4′-diaminodicyclohexylmethane (given a low proportion of trans, trans-isomer),
the copolyamide composed of terephthalic acid and/or isophthalic acid and of an alkyl-substituted bis(4-aminocyclohexyl)methane homolog, if appropriate in a mixture with hexamethylenediamine,
the copolyamide composed of bis(4-amino-3-methyl-5-ethylcyclohexyl)methane, if appropriate together with a further diamine, and isophthalic acid, if appropriate together with a further dicarboxylic acid,
the copolyamide composed of a mixture of m-xylylenediamine and a further diamine, e.g. hexamethylenediamine, and isophthalic acid, if appropriate together with a further dicarboxylic acid, e.g. terephthalic acid and/or 2,6-naphthalenedicarboxylic acid,
the copolyamide composed of a mixture of bis(4-aminocyclohexyl)methane and bis(4-amino-3-methylcyclohexyl)methane and aliphatic dicarboxylic acids having from 8 to 14 carbon atoms, and
polyamides or copolyamides composed of a mixture which comprises 1,14-tetradecanedioic acid and an aromatic, arylaliphatic or cycloaliphatic diamine.

These examples can be varied very substantially by addition of further components (e.g. caprolactam, laurolactam or diamine/dicarboxylic acid combinations) or by partial or complete replacement of starting components by other components.

The polyamides mentioned, and further suitable substantially amorphous polyamides, and suitable preparation methods, are described, inter alia, in the following patent applications: WO 02090421, EP-A-0 603 813, DE-A 37 17 928, DE-A 100 09 756, DE-A 101 22 188, DE-A 196 42 885, DE-A 197 25 617, DE-A 198 21 719, DE-C 198 41 234, EP-A-1 130 059, EP-A 1 369 447, EP-A 1 595 907, CH-B-480 381, CH-B-679 861, DE-A-22 25 938, DE-A-26 42 244, DE-A-27 43 515, DE-A-29 36 759, DE-A-27 32 928, DE-A-43 10 970, EP-A-0 053 876, EP-A-0 271 308, EP-A-0 313 436, EP-A-0 725 100 and EP-A-0 725 101.

Another suitable substrate material is polyalkyl (meth)acrylates having from 1 to 6 carbon atoms in the carbon chain of the alkyl moiety, where the methyl group is preferred as alkyl group. The melt flow rate of the polyalkyl (meth)acrylates is usually from 0.5 to 30 g/10 min, preferably from 0.8 to 15 g/10 min, measured to ISO 1133 at 230° C. using a load of 3.8 kg. Examples that may be mentioned are, inter alia, polymethyl methacrylate and polybutyl methacrylate. However, it is also possible to use copolymers of the polyalkyl (meth)acrylates. It is therefore possible to replace up to 50% by weight, preferably up to 30% by weight and particularly preferably up to 20% by weight, of the alkyl (meth)acrylate by other monomers, e.g. (meth)acrylic acid, styrene, acrylonitrile, acrylamide, or the like. Copolymers composed of methyl methacrylate and dicyclopentyl methacrylate are also suitable. The molding composition can be rendered impact-resistant, for example by addition of a core-shell rubber conventional for molding compositions of this type. Other thermoplastics, such as SAN (styrene/acrylonitrile copolymer), and/or polycarbonate can also be present in amounts of less than 50% by weight, preferably not more than 40% by weight, particularly preferably not more than 30% by weight and with particular preference not more than 20% by weight.

The substrate can also be composed of a molding composition which comprises a polycarbonate as main constituent. Polycarbonates suitable according to the invention contain units which are diesters of diphenols with carbonic acid. The diphenols can by way of example be the following: hydroquinone, resorcinol, dihydroxybiphenyls, bis(hydroxyphenyl)alkanes, bis(hydroxy-phenyl)cycloalkanes, bis(hydroxyphenyl)sulfides, bis(hydroxyphenyl)ethers, bis(hydroxyphenyl)ketones, bis(hydroxyphenyl)sulfones, bis(hydroxyphenyl)sulfoxides, α,α′-bis(hydroxyphenyl)diisopropylbenzenes, and also their ring-alkylated or ring-halogenated derivatives, or else α,ω-bis(hydroxyphenyl)polysiloxanes.

Examples of preferred diphenols are 4,4′-dihydroxybiphenyl, 2,2-bis(4-hydroxyphenyl)propane (bisphenol A), 1,1-bis(4-hydroxyphenyl)-3,3,5-trimethylcyclohexane, 1,1-bis(4-hydroxyphenyl)cyclohexane, 2,4-bis(4-hydroxyphenyl)-2-methylbutane, 1,1-bis(4-hydroxyphenyl)-1-phenylethane, 1,1-bis(4-hydroxyphenyl)-p-diisopropylbenzene, 1,3-bis[2-(4-hydroxyphenyl)-2-propyl]benzene, 2,2-bis(3-methyl-4-hydroxyphenyl)propane, 2,2-bis(3-chloro-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 2,2-bis(3,5-dichloro-4-hydroxyphenyl)propane and 2,2-bis(3,5-dibromo-4-hydroxyphenyl)propane.

The diphenols can be used either alone or else in a mixture with one another. The diphenols are known from the literature or can be prepared by methods known from the literature (see, for example, B. H. J. Buysch et al., Ullmann's Encyclopedia of Industrial Chemistry, VCH, New York 1991, 5th Edn., Vol. 19, p. 348).

The polycarbonates used according to the invention are prepared by known methods, for example by the interfacial process or by the melt transesterification process. Their weight-average molecular weights Mw (determined by gel permeation chromatography and calibration with a polystyrene standard) are from 5000 to 200 000, preferably from 10 000 to 80 000 and particularly preferably from 15 000 to 40 000.

The polycarbonate molding composition can by way of example comprise less than 50% by weight, preferably less than 40% by weight, particularly preferably less than 30% by weight and with particular preference less than 20% by weight, based on the entire underlying polymer, of other polymers, examples being polyethylene terephthalate, polybutylene terephthalate, polyesters composed of cyclohexanedimethanol, ethylene glycol and terephthalic acid, polyesters composed of cyclohexanedimethanol and cyclohexanedicarboxylic acid, polyalkyl (meth)acrylates, SAN, styrene-(meth)acrylate copolymers, polystyrene (amorphous or syndiotactic), polyetherimides, polyimides, polysulfones, polyarylates (e.g. based on bisphenol A and isophthalic acid/terephthalic acid).

Polyester carbonates are composed of at least one diphenol, of at least one aromatic dicarboxylic acid and of carbonic acid. Diphenols suitable are the same as those for polycarbonate. Based on the sum of the fractions deriving from aromatic dicarboxylic acids and carbonic acid, the fraction deriving from aromatic dicarboxylic acids amounts to not more than 99.9 mol %, not more than 95 mol %, not more than 90 mol %, not more than 85 mol %, not more than 80 mol % or not more than 75 mol %, while their minimum proportion amounts to 0.1 mol %, 5 mol %, 10 mol %, 15 mol %, 20 mol % or 25 mol %. Examples of suitable aromatic dicarboxylic acids are orthophthalic acid, terephthalic acid, isophthalic acid, tert-butylisophthalic acid, 3,3′-diphenyldicarboxylic acid, 4,4′-diphenyl ether dicarboxylic acid, 4,4′-diphenyl sulfone dicarboxylic acid, 3,4′-benzophenonedicarboxylic acid, 2,2-bis(4-carboxyphenyl)propane and trimethyl-3-phenylindane-4,5-dicarboxylic acid. Among these, preference is given to use of terephthalic acid and/or isophthalic acid.

Suitable thermoplastic polyesters are preferably of either fully aromatic or mixed aliphatic/aromatic structure. In the first case, these are polyarylates; these derive from diphenols and from aromatic dicarboxylic acids. Suitable diphenols are the same as those for polycarbonate, while suitable dicarboxylic acids are the same as those for polyester carbonates. In the second case, the polyesters derive from one or more aromatic dicarboxylic acids and from one or more diols; examples of these are polyethylene terephthalate or copolyesters composed of terephthalic acid, 1,4-cyclohexanedimethanol and ethylene glycol.

Suitable polysulfones are generally prepared by polycondensation of a bisphenol/dihalodiaryl sulfone mixture in an aprotic solvent in the presence of a base, e.g. sodium carbonate. Examples of bisphenol that can be used are those also suitable for the preparation of polycarbonates, but in particular bisphenol A, 4,4′-dihydroxydiphenyl sulfone, 4,4′-dihydroxybiphenyl and hydroquinone, and mixtures composed of various bisphenols can also be used. In most cases, the dihalo compound is 4,4′-dichlorodiphenyl sulfone; however, it is also possible to use any other dihalo compound in which the halogen has activation by a para-positioned sulfone group. Fluorine is another suitable halogen, alongside chlorine. The expression “polysulfone” also includes the polymers usually termed “polyether sulfone” or “polyphenylene sulfone”. Suitable types are commercially available.

Polyimides are prepared in a known manner from tetracarboxylic acids or from their anhydrides, and from diamines. If the tetracarboxylic acid and/or the diamine contains an ether group, the product is a polyetherimide. The compound I is one particularly suitable tetracarboxylic acid containing ether groups; together with aromatic diamines, it gives amorphous polyetherimides which are commercially available.

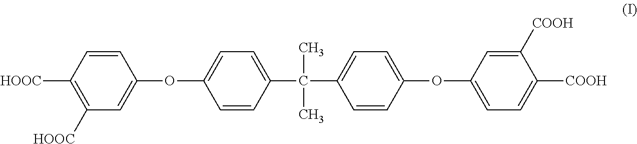

Other suitable polyimides are polymethacrylimides, sometimes also termed polyacrylimides or polyglutarimides. These are products based on polyalkyl acrylates or on polyalkyl methacrylates, in which two adjacent carboxylate groups have been reacted to give a cyclic imide. Imide formation is preferably carried out using ammonia or using primary amines, e.g. methylamine. The products and their preparation are known (Hans R. Kricheldorf, Handbook of Polymer Synthesis, Part A, Verlag Marcel Dekker Inc. New York-Basle-Hong Kong, p. 223 et seq., H. G. Elias, Makromoleküle [Macromolecules], Hiithig and Wepf Verlag Basle-Heidelberg-New York; U.S. Pat. No. 2,146,209 A; U.S. Pat. No. 4,246,374).

Examples of suitable styrene polymers are homopolystyrene or copolymers of styrene having up to 50 mol %, based on the monomer mixture, of other monomers, e.g. methyl methacrylate, maleic anhydride, acrylonitrile or maleimides. Styrene-maleimide copolymers are also, for example, available by reaction of styrene-maleic anhydride copolymers with ammonia or with primary amines, such as methylamine or aniline.

Polyolefins having cyclic units can be prepared (WO 00/20496, U.S. Pat. No. 5,635,573, EP-A-0 729 983, EP-A-0 719 803) by copolymerization of at least one cyclic or polycyclic olefin, for example norbornene or tetracyclododecene, with at least one acyclic olefin, such as ethene. This class of substance is termed COC. Another suitable class of substance, which is usually termed COP, is provided by unhydrogenated or hydrogenated products of the ring-opening metathetic polymerization of polycyclic olefins, such as norbornene, dicyclopentadiene, or substituted derivatives or Diels-Alder adducts thereof (EP-A-0 784 066, WO 01/14446, EP-A-0 313 838, U.S. Pat. No. 3,676,390, WO 96/20235).

Olefin-maleimide copolymers are known, for example, from U.S. Pat. No. 7,018,697.

Polymers based on vinylcyclohexane can be prepared (WO 94/21694, WO 00/49057, WO 01/30858; F. S. Bates et al., PCHE-Based Pentablock Copolymers: Evolution of a New Plastic, AIChE Journal Vol. 47, No. 4, pp. 762-765) either by polymerization or copolymerization of vinylcyclohexane or by catalytic hydrogenation of styrene polymers.

The molding composition of the substrate can also comprise other familiar auxiliaries or additives, e.g. stabilizers, processing aids, flame retardants, plasticizers, antistats, isorefractive fillers or isorefractive reinforcing materials, isorefractive impact modifiers, dyes which do not significantly impair transparency, flow aids, mold-release agents or other polymers which do not significantly impair transparency. If the application does not demand substrate transparency, there is no need for the filters and reinforcing materials and the impact modifiers to be isorefractive. Nor are there any restrictions in this instance on the dyes and any pigments present or on any other polymers present. The total amount of all auxiliaries and additives amounts to not more than 50% by weight, preferably not more than 40% by weight, particularly preferably not more than 30% by weight, and with particular preference not more than 20% by weight.

The bonding of the outer layer to the substrate can take place in any known manner, for example by multicomponent injection molding, coextrusion, reverse coating of a film by an injection-molding method, reverse foaming of a film, extrusion-lamination, lamination, pressing or adhesive bonding.

Multicomponent injection molding serves for production of moldings with layers or regions composed of different plastics or colorings. Various variants of the process are possible and known to the person skilled in the art. Two or more injection-molding units are generally used, operating in succession into a mold. Once the first unit has filled one mold cavity, the mold cavity is enlarged for the injection-molding procedure from the second unit, for example by displacement movements of the mold halves, rotation of mold halves or of mold parts, or core-puller movements to provide access to additional cavity regions. It is also possible to operate sequentially using a plurality of molds on standard single-component machines, by respective placing of moldings into the next mold and applying the following subcomponent by injection. In another possible method of operation, the first unit is used for partial filling of the mold and the melt from the second unit displaces the melt from the first unit from the core region towards the surface of the molding, whereupon the finished component has a skin-core structure (sandwich structure). Another variant is the monosandwich process, in which the melts are conveyed by way of two separate plastifying units into a shared injection space and are spatially layered in succession. One of the subcomponents then displaces the other subcomponent towards the surface during the injection procedure.

Multilayer structures, e.g. sheets, can by way of example be produced by coextrusion. In coextrusion, a plurality of melt streams of plastics of similar type or of different type are combined with one another. The variants of the process are known to the person skilled in the art. In principle, combination of the melts can take place prior to, in or downstream of a die. Coalescence of the melts downstream of (e.g. in blow molding) or in the die has the advantage that the melts can receive different heat treatments. In the case of “adapter dies”, the melts coalesce prior to entry into the shaping die. The multilayer structures (e.g. multilayer sheets) can be calendered where possible. An alternative is the chill-roll process. The coextrusion process can be supplemented by a subsequent blow-molding process.

In the reverse coating of a film by an injection-molding method, the film is placed in an injection mold, if appropriate after prior subjection to a forming process (e.g. thermoforming), and is then brought into contact with the melt of the substrate. This gives a composite component. The various variants of the process are known to the person skilled in the art. In one variant of this process, the mold is only partially filled with the melt after the film has been put in place, and then space within the mold is reduced in a controlled manner by displaceable parts in a manner similar to that for the injection-compression molding process.

The reverse foaming of thermoformed films is advantageous for large-surface-area and flat components, where the costs for injection-molding machines and injection molds for the reverse coating process would be very high. By way of example, use of the LFI process for reverse foaming in the invention can apply a mixture of long glass fibers and polyurethane foam to the reverse side of a thermoformed part. Hardening of the polyurethane-glass mixture gives components with high stiffness and heat resistance but low intrinsic weight.

Other processes can also be used to produce the composite material, an example being extrusion-lamination. Here, a prefabricated substrate is continuously combined with a prefabricated outer layer, the bond being brought about by a plastics melt which is input at the contact site of the first-mentioned components. This gives a three-layer structure. One variant consists in extruding the substrate material onto the prefabricated outer layer, or the outer layer onto a prefabricated substrate. Continuous lamination processes provide another route, where the bond is realized by introducing adhesives (solvent-based, hot-melts, etc.).

As an alternative, it is also possible to produce composites by press processes, where the bond between the prefabricated adherends is brought about by exposure to pressure and heat, e.g. in a press. This process, too, can also use adhesives, etc.

A welding process (e.g. laser welding) can in principle also be used for bonding outer layer and substrate or semifinished film product and substrate.

The surface can by way of example be structured by embossing. It is also possible to structure the surface in advance in the context of the film-extrusion process, for example by using specifically designed rolls. The resultant composite part can then be subjected to a forming process.

The bond between outer layer and substrate can be achieved by interlock bonding, for example by means of undercuts. However, preference is generally given to a coherent bond. For this, the materials must adhere to one another, and this is achieved by way of example by chemical bonding or by intertwining of macromolecules.

Suitable combinations of materials which adhere firmly to one another are known to the person skilled in the art or can be determined by simple experimentation. In cases where it is impossible to achieve adequate adhesion, an adhesion promoter can be used, for example in the form of a multilayer film, comprising an adhesion-promoter layer on the substrate side. The nature of the adhesion promoter is not critical; however, it should preferably have sufficient transparency at the layer thickness selected.

In one embodiment, the adhesion promoter comprises a blend composed of a polymer which is identical with, or similar to, the polymer of the adjoining film layer, and also of a polymer which is identical with, or similar to, the polymer of the substrate. “Similar” means that the relevant polymers can be mixed in the melt to give phase-stable blends, and, respectively, that layers composed of the two polymers have adequate adhesion to one another after coextrusion or in-mold coating, i.e. that the polymers are compatible with one another. Compatible polymer combinations are known to the person skilled in the art or can be determined by simple experimentation. The blend is usually prepared by mixing in the melt. Suitable mixing ratios in percent by weight are from 20:80 to 80:20, preferably from 30:70 to 70:30 and particularly preferably from 40:60 to 60:40. A compatibilizer can be used concomitantly if appropriate, an example being a branched polymer, such as a polyamine-polyamide graft copolymer (EP-A-1 065 048), a polymer having reactive groups and capable of entering into a chemical reaction at least with one of the constituents of the blend, or a block copolymer. In many instances, polyurethanes are also suitable as adhesion promoters.

In another embodiment, the adhesion promoter comprises from 2 to 100% by weight, preferably from 5 to 90% by weight, particularly preferably from 10 to 80% by weight, with particular preference from 15 to 60% by weight and very particularly preferably from 20 to 40% by weight, of a copolymer which contains the following monomer units:
from 70 to 99.9% by weight of monomer units which derive from vinyl compounds selected from acrylic acid derivatives, methacrylic acid derivatives, α-olefins and vinyl aromatics and
from 0.1 to 30% by weight of monomer units which contain a functional group selected from a carboxylic anhydride group, an epoxy group and an oxazoline group.

The copolymer preferably contains the following monomer units:
1. From about 70 to about 99.9% by weight, preferably from 80 to 99.4% by weight and particularly preferably from 85 to 99% by weight, of monomer units selected from units of the following formulae:

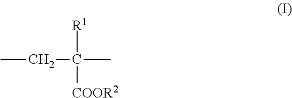

where R¹═H or CH₃ and R²═H, methyl, ethyl, propyl or butyl;

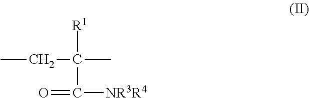

where R¹ is as above and R³ and R⁴, independently of one another, are H, methyl or ethyl;

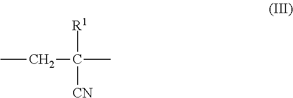

where R¹ is as above;

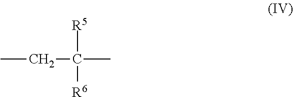

where R⁵═H or CH₃ and R⁶═H or C₆H₅;

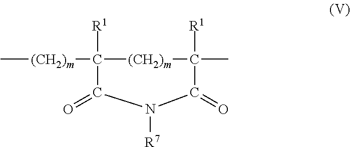

where is as above and R⁷═H, methyl, ethyl, propyl, butyl or phenyl and m=0 or 1;
2. from about 0.1 to about 30% by weight, preferably from 0.6 to 20% by weight and particularly preferably from 1 to 15% by weight of monomer units selected from units of the following formulae:

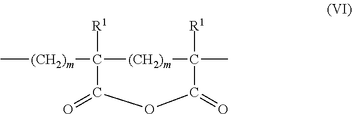

where R¹ and m are as above;

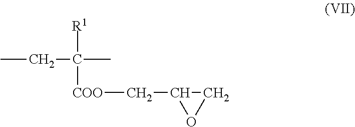

where R¹ is as above;

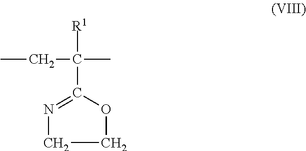

where R¹ is as above.

The limitation of chain length in the case of substituents R¹ to R⁵ and R⁷ is based on the fact that longer alkyl radicals lead to a lowered glass transition temperature and therefore to reduced heat resistance. This may be acceptable in a few cases.

The units of the formula (I) derive by way of example from acrylic acid, methacrylic acid, methyl acrylate, ethyl acrylate, n-butyl acrylate, methyl methacrylate, n-propyl methacrylate, or isobutyl methacrylate.

The units of the formula (II) derive by way of example from acrylamide, methacrylamide, N-methylacrylamide, N-methylmethacrylamide, or N,N-dimethylacrylamide.

The units of the formula (III) derive from acrylonitrile or methacrylonitrile.

The units of the formula (IV) derive from ethene, propene, styrene or α-methylstyrene; these can be replaced entirely or to some extent by other polymerizable aromatics, such as p-methylstyrene or indene, which have the same effect.

If m=0, the units of the formula (V) derive from unsubstituted or substituted maleimides, such as maleimide, N-methylmaleimide, N-ethylmaleimide, N-phenylmaleimide, or N-methylaconitimide. If m=1, they derive by reaction with ammonia or with a primary amine of two adjacent units of the formula (I) in a polymer, forming an imide.

If m=0, the units of the formula (VI) derive from unsubstituted or substituted maleic anhydrides, such as maleic anhydride or aconitic anhydride. These latter compounds can be replaced entirely or to some extent by other unsaturated acid anhydrides, e.g. itaconic anhydride, which have the same effect. If m=1, they derive by elimination of water from two adjacent units of the formula (I) in a polymer (R²═H), with ring closure.

The units of the formula (VII) derive from glycidyl acrylate or glycidyl methacrylate, and the units of the formula (VIII) derive from vinyloxazoline or isopropenyloxazoline.

Various embodiments of the copolymer are preferred, and contain the following units:
A. From 14 to 96% by weight, preferably from 20 to 85% by weight, and particularly preferably from 25 to 75% by weight, of units of the formula (I), where R² is not H;
   from 0 to 75% by weight, preferably from 1 to 60% by weight, and particularly preferably from 5 to 40% by weight, of units of the formula (V), where m=1;
   from 0 to 15% by weight, preferably from 0 to 10% by weight, and particularly preferably from 0.1 to 7% by weight, of units of the formula (I), where R²═H;
   from 0.1 to 30% by weight, preferably from 1 to 20% by weight, and particularly preferably from 2 to 15% by weight, of units of the formula (VI), where m=1.

If units of the formula (V) are present, these copolymers are termed polyacrylimides or polymethacrylimides or sometimes also polyglutarimides. These are products which come from polyalkyl acrylates and, respectively, polyalkyl methacrylates, in which two adjacent carboxylate groups have been reacted to give a cyclic imide. The imide is preferably formed with ammonia or with primary amines, e.g. methylamine, in the presence of water, and the units of the formula (VI) and, where appropriate, units of the formula (I), where R²═H, are produced concomitantly by hydrolysis. The products are known, as also is their preparation (Hans R. Kricheldorf, Handbook of Polymer Synthesis, Part A, Verlag Marcel Dekker Inc. New York-Basle-Hong Kong, p. 223 et seq., H, G. Elias, Makromoleküle [Macromolecules], Hiithig and Wepf Verlag Basle-Heidelberg-New York; U.S. Pat. No. 2,146,209 A; U.S. Pat. No. 4,246,374). If water only is used for the reaction, the product is units of the formula (VI) and also, if appropriate, acidic units (I) by hydrolysis, without formation of imide units (V).
B. From 10 to 60% by weight, preferably from 15 to 50% by weight and particularly preferably from 20 to 40% by weight of units of the formula (IV);
   from 39.9 to 80% by weight, preferably from 44.9 to 75% by weight and particularly preferably from 49.9 to 70% by weight of units of the formula (III);
   from 0.1 to 30% by weight, preferably from 0.6 to 20% by weight and particularly preferably from 1 to 15% by weight of units of the formula (VI), where m=0.
   Copolymers of this type are obtainable in a known manner by free-radical-initiated copolymerization of, for example, aliphatically unsaturated aromatics, unsaturated carboxylic anhydrides, and acrylonitrile or methacrylonitrile.
C. From 39.9 to 99.9% by weight, preferably from 49.9 to 99.4% by weight and particularly preferably from 59.9 to 99% by weight, of units of the formula (I);
   from 0 to 60% by weight, preferably from 0.1 to 50% by weight and particularly preferably from 2 to 40% by weight of units of the formula (IV);
   from 0.1 to 30% by weight, preferably from 0.6 to 20% by weight and particularly preferably from 1 to 15% by weight of units of the formula (VI), where m=0.
   Copolymers of this type are obtainable in a known manner by free-radical-initiated copolymerization of acrylic acid, methacrylic acid and/or esters thereof and, if appropriate, aliphatically unsaturated aromatics or olefins and unsaturated carboxylic anhydrides.
D. From 25 to 99.8% by weight, preferably from 40 to 98.4% by weight and particularly preferably from 50 to 97% by weight of units of the formula (I);
   from 0.1 to 45% by weight, preferably from 1 to 40% by weight and particularly preferably from 2 to 35% by weight of units of the formula (III);
   from 0.1 to 30% by weight, preferably from 0.6 to 20% by weight and particularly preferably from 1 to 15% by weight of units of the formula (VI), where m=0.
   Copolymers of this type are obtainable in a known manner by free-radical-initiated copolymerization of acrylic acid, methacrylic acid, and/or esters thereof, or acrylonitrile or methacrylonitrile and unsaturated carboxylic anhydrides.
E. From 0 to 99.9% by weight, preferably from 0.1 to 99.4% by weight, and particularly preferably from 2 to 99% by weight, of units selected from the formulae (I), where R² is not H, and (III),
   from 0 to 60% by weight, preferably from 0.1 to 50% by weight, and particularly preferably from 2 to 40% by weight, of units of the formula (IV),
   from 0.1 to 30% by weight, preferably from 0.6 to 20% by weight, and particularly preferably from 1 to 15% by weight, of units of the formula (VII).
F. From 0 to 99.9% by weight, preferably from 0.1 to 99.4% by weight, and particularly preferably from 2 to 99% by weight, of units selected from the formulae (I), where R² is not H, and (III),
   from 0 to 60% by weight, preferably from 0.1 to 50% by weight, and particularly preferably from 2 to 40% by weight, of units of the formula (IV),
   from 0.1 to 30% by weight, preferably from 0.6 to 20% by weight, and particularly preferably from 1 to 15% by weight, of units of the formula (VIII).

The copolymer can always contain other additional monomer units, such as those which derive from maleic diesters, from fumaric diesters, from itaconic esters or from vinyl acetate, as long as the desired adhesion-promoting effect is not substantially impaired thereby.

In one embodiment, the adhesion promoter can be composed entirely of the copolymer; in a variant of this, the copolymer comprises an impact modifier, e.g. an acrylate rubber.

In another embodiment, the adhesion promoter comprises from 2 to 99.9% by weight, preferably from 5 to 90% by weight, particularly preferably from 10 to 80% by weight, with particular preference from 15 to 60% by weight, and very particularly preferably from 20 to 40% by weight, of the copolymer, and from 0.1 to 98% by weight, preferably from 10 to 95% by weight, particularly preferably from 20 to 90% by weight, with particular preference from 40 to 85% by weight, and very particularly preferably from 60 to 80% by weight, of a polymer selected from the group of the polyamide of the adjoining film layer, the polymer of the substrate, polyamide similar to the polyamide of the adjoining film layer, polymer similar to the polymer of the substrate, and mixtures thereof.

The adhesion promoter can comprise the usual auxiliaries and additives, e.g. flame retardants, stabilizers, plasticizers, processing aids, dyes or the like. The amount fed of the agents mentioned is to be such as not to give any serious impairment of the desired properties.

In the case of combinations of materials which are difficult to bond, it can be advisable to use two successive mutually compatible adhesion-promoter layers, one of which couples to the polyamide layer and the other of which couples to the substrate.

In one preferred embodiment, the component is produced by bonding of a decorative film to the substrate. For the purposes of the invention, decorative films are films which can be printed and/or which comprise a color layer, and moreover are intended to be bonded to a substrate in order to decorate the surface of the same. The decoration can also be achieved by subjecting optical defects on the surface to a lamination process, e.g. by covering surface roughness that derives from fillers or from reinforcing materials.

The decorative film of the invention has one or more layers. The nature and number of the other layers in a multilayer embodiment depend on the performance requirements; the only decisive factor is that the outer layer is composed of the molding composition used in the invention.

Examples of possible embodiments are the following
1. The film has one layer. In this case it is defined as being composed solely of the outer layer; decorative effects can be applied by printing, e.g. by means of thermal sublimation printing on either the upper side or the lower side.
2. The film comprises not only the outer layer but also a lower color layer. The color layer can be a paint layer; however, as in the prior art it is preferably composed of a colored thermoplastic layer. The constitution of the thermoplastic can by way of example be identical with or similar to that of the outer layer, or the thermoplastic can comprise a component thereof, or another polyamide, or another polymer, which adheres either directly on the outer layer or has been adhesive-bonded with the aid of an adequately transparent adhesion promoter (for example a polyolefin that has been functionalized by carboxy groups or by anhydride groups, or by epoxy groups, or a thermoplastic polyurethane or a blend of the constituents of the layers that require bonding). Examples of colorants that can be used are organic dyes, inorganic or organic pigments, or metal flakes. The perceived color has good depth, because the outer layer is transparent.
3. The film comprises not only the outer layer and, if appropriate, color layer, but also a further layer, which is a backing layer that provides adequate mechanical strength and, if appropriate, also bonding to the substrate.
4. The film comprises not only the outer layer and, if appropriate, color layer, but also a lower adhesion-promoter layer for bonding to the substrate. Examples of suitable adhesion promoters are a polyolefin functionalized by carboxy or anhydride groups, or by epoxy groups, a thermoplastic polyurethane, a blend of the materials of the layer that requires bonding and the materials of the substrate, or any of the adhesion promoters described in more detail above.
5. The film comprises not only the outer layer and, if appropriate, the color layer and backing layer, but also a lower adhesion-promoter layer for bonding to the substrate. For the adhesion promoter, the information in point 4 is again applicable.
6. If necessary, e.g. if there are relatively stringent requirements for scratch resistance, the film, e.g. a film as in points 1 to 5, also comprises a protective layer on the outer layer, an example being a clear polyurethane-based varnish. It is possible here to use coating compositions which can be cured in two stages. A film with this type of coating can by way of example still be subjected to a forming process after the first curing stage; the second curing stage is delayed until the film has been subjected to the forming process or until by way of example a molding has been produced by reverse coating of the film by an injection-molding method. A protective layer in the form of a paint can also have been modified in order to increase scratch resistance as in the prior art, e.g. with nanoparticles. Another possibility alongside these is to generate a protective layer on the component by way of the vacuum-deposition process. The film can, if appropriate, also comprise a peelable protective film applied by lamination which provides protection during transport or installation and by way of example is peeled away after production of the composite part.

In the case of embodiments 2 to 6, the transparent outer layer can first be printed in the manner of a monofilm from one side or from both sides, before a second step in which it is bonded to the other layers to give the multilayer film. In multilayer films produced for example by coextrusion, the transparent outer layer can be printed from above. The outer layer can also have been colored by use of a transparent or opaque material.

In one preferred embodiment, the color layer and/or the backing layer and/or the adhesion-promoter layer comprises a molding composition, in particular of a polyetheramide or of a polyetheresteramide, and preferably of a polyetheramide or polyetheresteramide based on a linear aliphatic diamine having from 6 to 18 and preferably from 6 to 12 carbon atoms, a linear aliphatic or an aromatic dicarboxylic acid having from 6 to 18 and preferably from 6 to 13 carbon atoms, and a polyether having an average of more than 2.3 carbon atoms per oxygen atom and a number-average molecular weight of from 200 to 2000. The molding composition of said layer can comprise further blend components, e.g. polyacrylates or polyglutarimides having carboxy or carboxylic anhydride groups or epoxy groups, a rubber containing functional groups, and/or a polyamide. Molding compositions of this type are prior art; they are described by way of example in EP 1 329 481 A2 and DE-A 103 33 005, which are expressly incorporated herein by way of reference. In order to provide good layer adhesion it is advantageous that the polyamide content of the polyamide elastomer here is composed of monomers identical with those used in the outer layer. However, this is not an essential requirement for achieving good adhesion. As an alternative to the polyamide elastomer, the color layer and/or the backing layer can also comprise, alongside a polyamide, a conventional impact-modifying rubber. An advantage of said embodiments is that in many instances there is no need for thermoforming of the film as a separate step prior to the reverse coating by an injection-molding method, since the reverse coating by an injection-molding method simultaneously also subjects the film to a forming process.

In one preferred embodiment, the thickness of the film is from 0.02 to 1.2 mm, particularly preferably from 0.05 to 1 mm, very particularly preferably from 0.08 to 0.8 mm and with particular preference from 0.15 to 0.6 mm. In one preferred embodiment here, the thickness of the adhesion-promoter layer is from 0.01 to 0.5 mm, particularly preferably from 0.02 to 0.4 mm, very particularly preferably from 0.04 to 0.3 mm and with particular preference from 0.05 to 0.2 mm. The film is produced by means of known methods, for example by extrusion, or in the case of multilayer systems by coextrusion or lamination. It can then, if appropriate, be subjected to a forming process.

If the component is produced by multicomponent injection molding, the thickness of the outer layer is generally from 0.1 to 10 mm, preferably from 0.2 to 7 mm and particularly preferably from 0.5 to 5 mm. Layer thicknesses below 0.1 mm are also possible under specific processing conditions. Low thicknesses generally lead to better transparency of the component. In the case of production by coextrusion, the thickness of the outer layer is generally from 0.02 to 1.2 mm, preferably from 0.05 to 1.0 mm, particularly preferably from 0.08 to 0.8 mm, and with particular preference from 0.12 to 0.6 mm. These thickness data for the outer layer also apply to the outer layer of the decorative film of the invention.

The substrate can have any desired thickness. Its thickness is generally in the range from 0.5 to 100 mm, preferably in the range from 0.8 to 80 mm, particularly preferably in the range from 1 to 60 mm, with particular preference in the range from 1.2 to 40 mm, and very particularly preferably in the range from 1.4 to 30 mm. Further preference is given to upper thickness limits of 25 mm, 20 mm, 15 mm, 10 mm, 6 mm, 5 mm, and 4 mm. The thickness is to be selected in such a way that the component has the required stiffness. The component of the invention is not a film; it is unlike a film in that it is dimensionally stable.

In one embodiment, the component of the invention is used in the form of transparent, for example optical, component. Examples of these are diffuser sheets, headlamp lenses, tail-light lenses, spectacle lenses, other types of lens, prisms, displays, decorative components for displays, elements of lighting systems, backlit switches, paneling of any type, and mobile-telephone casings.

In other embodiments, the film of the invention is used as outer layer of a film composite for the design or decoration of surfaces on and in automobiles and commercial vehicles, where the film has been adhesive-bonded to a plastics substrate. The correspondingly designed component can be sheet-like, an example being a bodywork part, such as roof module, wheel surround, engine hood, or door. Other embodiments that can also be used are those in which elongate components with varying degrees of curvature are produced, examples being cladding, such as the cladding of what are known as A-columns on automobiles, or decorative strips and cover strips of any type. Another example is provided by protective cladding for door sills. Alongside applications in motor-vehicle exteriors, it is also possible to use the films of the invention advantageously to decorate constituents of the interior, particular examples being decorative elements, such as strips and panels, since the interior also requires impact resistance and resistance to chemicals, such as cleaners. The plastics substrate does not have to be transparent here. Substrates used in automobile constructions often comprise reinforced molding compositions which comprise by way of example glass fibers or talc and are therefore not transparent. Another example of an instance where transparency of the substrate is not a logical requirement occurs when an opaque color layer is used in a multilayer film composite.

In another embodiment, the film of the invention is used as topcoat for sports equipment, for example any type of snowboard-like equipment, such as skis or snowboards.

U.S. Pat. No. 5,437,755 describes a known process for applying decorated ski topcoats. In this process, the ski is produced by what is known as the monocoque system, the topcoat initially being composed of two plastic films, of which the outer is transparent and the inner is opaque (white). Before the two films are adhesive-bonded to one another, and before the subsequent thermoforming process, the outer side of the transparent upper film and one of the subsequent contact surfaces between the transparent upper film and the opaque lower film are printed with various decorative effects. Suitable plastics stated for the upper film are acrylonitrile-butadiene-styrene copolymer (ABS), acrylonitrile-styrene copolymer (AS), thermoplastic polyurethane (TPU) and aliphatic polyamides, particularly PA11 and PA12. Materials described for the lower foil, which is protected from external effects and is not always printed, are copolyamides, alongside polyesteramides, polyetheramides, modified polyolefins, and styrene-carboxylic anhydride copolymers. However, it is also possible to use any of the other known shaping and adhesive-bonding processes for bonding of the topcoat to the ski or snowboard.

If a monofilm is used in the invention, this is transparent and is preferably printed on the lower side, and in this case an adhesive which is white or, if appropriate, has a different color is used as optical background for the bonding of the film to the ski.

If a coextruded two-layer film is used, this is preferably composed of a transparent upper layer and of a white or color-pigmented lower layer as background, with a print on the upper side of the film.

The film can by way of example be decorated by screen printing or offset printing, but can also give good results in thermal diffusion printing or sublimation printing. These thermal printing processes frequently require relatively high heat resistance of the films or moldings. In the case of the molding compositions used here, heat resistance correlates with the crystallite melting point Tₘ; Tₘ of at least 180° C. is desirable for these thermal printing processes. Inadequate heat resistance values become visible through warpage or deformation of the films or moldings to be printed. On the other hand, lowering of the sublimation temperature impairs contrast and print image sharpness, because the ink then fails to penetrate sufficiently deeply into the film. The crystallite melting point Tₘ of PA613 is 194° C., and molding compositions based thereon are therefore superior here to those based on PA12 (Tₘ=178° C.).

The film can moreover by way of example be used as film for protection from soiling, UV radiation, effects of weathering, chemicals, or abrasion, or as barrier film, on vehicles, in households, on floors, tunnels, tenting, and buildings, or as carrier for decorative effects, for example for topcoats of boats or of aircraft, or in households, or on buildings.

The examples below are intended to illustrate the invention.

The relative viscosity ηᵣₑₗ of the polyamides was determined to DIN EN ISO 307. The end groups were determined in the usual way by titration.

### PRODUCTION EXAMPLE 1

A PA613 was produced by charging the following starting materials to a 200 1 polycondensation reactor:

30.320 kg of hexamethylenediamine (69.00%)
44.683 kg of tridecanedioic acid (brassylic acid)
6.900 kg of demineralized H₂O
6.732 g of a 50% strength aqueous solution of hypophosphorous acid
(corresponding to 57 ppm).

The starting materials were melted under nitrogen and heated to about 190° C. in a sealed autoclave, with stirring, the resultant internal pressure being about 14 bar. Said internal pressure was maintained for three hours; the melt was then heated to about 215° C. and stirred at the resultant internal pressure of about 20 bar. The mixture was then further heated to an internal temperature of 250° C., with continuous depressurization to atmospheric pressure. In accordance with the viscosity required, nitrogen was passed over the melt for about 1 hour while maintaining the temperature at 250° C., until the desired torque was indicated. The melt was discharged by means of a gear pump as a strand which was introduced to the pelletization process. The pellets were dried at 80° C. for 16 hours under the vacuum provided by a water pump.

Amount of material discharged: 54 kg

The properties of the product were as follows:

crystallite melting point Tₘ: 194/207° C.
enthalpy of fusion: about 87 J/g
relative solution viscosity ηᵣₑₗ: 1.88
COOH end groups: 35 mmol/kg
NH₂ end groups: 78 mmol/kg

In order to increase the molecular weight of the PA613 polycondensation product, 53 kg of pellets were post-condensed for a period of about 26 hours in a tumbling drier under a stream of nitrogen at atmospheric pressure with an oil-input temperature of about 160° C.

Amount of material discharged from solid-phase post-condensation process: 53 kg

The properties of the product were as follows:

crystallite melting point Tₘ: 194/205° C.
enthalpy of fusion: about 87 J/g relative solution viscosity ηᵣₑₗ: 2.21
COOH end groups: 9 mmol/kg
NH₂ end groups: 59 mmol/kg

### PRODUCTION EXAMPLE 2

The polycondensation process was carried out as in production example 1, but using the following starting materials:

29.858 kg of hexamethylenediamine (68.61%)
44.683 kg of tridecanedioic acid (brassylic acid)
6.900 kg of demineralized H₂O
6.732 g of a 50% strength aqueous solution of hypophosphorous acid
(corresponding to 57 ppm).

Amount of material discharged from the polycondensation process: 56 kg

The properties of the product were as follows:

crystallite melting point Tₘ: 197/207° C.
enthalpy of fusion: about 94 J/g
relative solution viscosity ηᵣₑₗ: 1.84
COOH end groups: 106 mmol/kg
NH₂ end groups: 18 mmol/kg

### Processing

### 1. Compounding

The product from the solid-phase post-condensation process in example 1 was compounded in a Werner+Pfleiderer ZSK30 M9/1(K3) kneader with a barrel temperature of 250° C. at 250 rpm with 8 kg/h throughput and with addition of 0.7% by weight of a conventional stabilizer composition.

### 2. Extrusion of Multilayer Films:

The stabilization-by-compounding process was followed by the film-extrusion process to give multilayer films with respective total thickness of 450 μm in a Collin film plant using the calender process and a melt temperature of about 250° C. Film structure:

PA613 (outer layer): 190 μm
PA12-based color layer: 150 μm
Admer® QF551E (functionalized polypropylene): 110 μm

For comparative examples, corresponding multilayer films were produced with a PA12 outer layer of thickness 190 μm.

3. Extrusion of monofilms

PA613 from example 3 was processed on the Collin film plant at a melt temperature of 240° C. to give monofilms of the thickness 190 μm and 1000 μm. For comparative examples, monofilms of thickness 190 μm were also produced from PA12, and monofilms of thickness 1000 μm were produced from PA1010, PA1012 and PA12.

### 4. Reverse Coating by an Injection-Molding Method

Monofilms of thickness 190 μm for the wash-brush test were produced by reverse coating by an injection-molding method, using an Engel Victory 650/200#159202 machine with high-gloss mold, and a PA12 molding composition. The dimensions of the resultant plaques were 150×105×3 mm.

### Tests

### 1. Transmittance

Transmittance was measured on monofilms of thickness 1000 μm to ISO 13468-2; see table 1. The films made of PA613 are seen to have improved transparency when comparison is made with the other polyamides.

2. Gloss Values after Accelerated Weathering and after Heat Aging

Accelerated weathering was carried out in two steps on multilayer films in a QUV/se Weathering Tester from Q-Panel.

Step 1: 55° C., exposure to light at 0.98 W/m² at 340 nm for 4 h
Step 2: 45° C., water condensation under dark conditions, 4 h

Initial gloss was determined, and then the variation of gloss values was determined at defined time intervals for the multilayer films during the weathering process; see table 2.

Heat aging (24 h at 120° C.) was carried out in a convection oven, and gloss measurements were made here prior to the aging process, and after 1 h and after 24 h of aging; see table 3.

The gloss measurements were carried out to DIN 67530 using an angle of incidence of 20° and an X-Write Acugloss reflectometer.

### 3. Wash-Brush-Resistance Test

The Amtec-Kistler wash-brush test provides a realistic simulation of the stress placed upon the surface in automatic washing systems, to ISO 20566. For this, the plaques made of the monofilms that have been subjected to reverse coating by an injection-molding method were used as test specimens and were moved to and fro in opposing direction under a horizontally rotating brush (rotation rate 120 min⁻¹). In order to achieve results that provide a very good simulation of actual practise, and in order to accelerate the test, powdered quartz was used as replacement for dirt and admixed with the wash water. Gloss measurements were then carried out as above using an angle of incidence of 20°. Table 4 shows the results.

TABLE 1
Transmittance at 400 nm with film thickness 1000 μm

| Polyamide | PA613 | PA1010 | PA1012 | PA12 |
|---|---|---|---|---|
| Transmittance in % | 82.61 | 79.17 | 60.77 | 75.78 |

TABLE 2
Variation of gloss values under accelerated weathering

| Outer layer | Gloss values after weathering period of | | | | | | | | | | |
|---|---|---|---|---|---|---|---|---|---|---|---|
| material | 0 h | 172 h | 352 h | 511 h | 670 h | 837 h | 1012 h | 1541 h | 2266 h | 2999 h | 4000 h |
| PA613 | 82.2 | 84.5 | 85.3 | 86.3 | 86.3 | 87.1 | 87.5 | 87.8 | 86.9 | 84.3 | 76.8 |
| PA12 | 76.2 | 65.7 | 63.7 | 63.6 | 60.1 | 58.0 | 55.8 | 53.5 | 53.6 | 51.4 | 40.1 |

TABLE 3
Heat aging at 120° C.

| Outer layer | Gloss values after heat aging for | | |
|---|---|---|---|
| material | 0 h | 1 h | 24 h |
| PA613 | 85.3 | 86.0 | 86.1 |
| PA12 | 78.5 | 61.0 | 38.1 |

TABLE 4
Wash-brush-resistance test

| | | |
|---|---|---|
| Outer layer | Gloss value | Residual gloss |

| material | Start | End | in % |
|---|---|---|---|
| PA613 | 86.8 | 27.8 | 32.0 |
| PA12 | 85.2 | 19.9 | 23.4 |

1. A component comprising the following component parts:
an outer layer comprising a molding composition which comprises at least 50% by weight of PA613, and
a substrate comprising a thermoplastic molding composition.

2. The component as claimed in claim 1,
wherein
the substrate is a molding composition comprising polyolefins, polyamides, polyesters, polyacrylates, polycarbonates, ABS, polystyrene, or styrene copolymers, or is a curable system comprising epoxy resin or polyurethane.

3. The component as claimed in claim 1, wherein the substrate has, within the visible spectrum from 380 to 800 nm, a maximum of at least 30% in the transmittance curve, determined to ASTM D1003 on injection-molded sheets when the thickness of the layer is 1 mm.

4. The component as claimed in claim 3,
wherein
the substrate is a molding composition comprising a substantially transparent polyamide, a polyalkyl (meth)acrylate, a polycarbonate, a polyester carbonate, a polyester, a polyimide, a polyetherimide, a polymethacrylimide, a polysulfone, a styrene polymer, a polyolefin having cyclic units, an olefin-maleimide copolymer, or a polymer comprising vinylcyclohexane.

5. The component as claimed in claim 1,
obtained by a process comprising
multicomponent injection molding, coextruding, reverse coating of a film by an injection-molding, reverse foaming of a film, extrusion-laminating, laminating, pressing, or adhesive bonding.

6. The component as claimed in claim 1,
comprising
an adhesion promoter between the outer layer and the substrate.

7. The component as claimed in claim 5,
obtained by a process comprising
subjecting a film to in-mold coating or to reverse foaming, where the film has, alongside the outer layer, a color layer and/or a polyamide layer as backing layer, and/or a supportive layer on the substrate side.

8. The component as claimed in claim 3, for optical applications.

9. The component as claimed in claim 3,
wherein said component is a component of
is a diffuser sheet, a headlamp lens, a tail-light lens, a spectacle lens, any other type of lens, a prism, a display, a decorative component for a display, an element of a lighting system, a backlit switch, a panel of any type, or a mobile-telephone casing.

10. The component as claimed claim 1,
wherein said component is a component of
a bodywork part of a motor vehicle, a constituent of the interior of a motor vehicle, or is cladding, a decorative strip, a cover strip, a panel, or a decorative element.

11. The component as claimed in claim 1,
wherein said component
is an item of sports equipment.

12. A decorative film, the outer layer of which is composed of a molding composition which comprises at least 50% by weight of PA613.

13. The decorative film as claimed in claim 12, which is composed only of said layer.

14. The decorative film as claimed in claim 12, which is composed of a plurality of layers.

15. The decorative film as claimed in claim 14, further comprising
a color layer and/or a backing layer, and/or an adhesion-promoter layer.

16. The decorative film as claimed in claim 15,
wherein
the color layer and/or the backing layer, and/or the adhesion-promoter layer comprise(s) a polyamide elastomer or an impact-modifying rubber.

17. The decorative film as claimed in claim 12,
having a
thickness from 0.02 to 1.2 mm.

18. The decorative film as claimed in claim 12,
wherein
the thickness of the adhesion-promoter layer is from 0.01 to 0.5 mm.

19. The decorative film as claimed in claim 12,
wherein said decorative film
is produced by extrusion, coextrusion, or lamination, and is then optionally subjected to a forming process.

20. (canceled)
